(19) United States
(12) Patent Application Publication
(10) Pub. No.: US 2025/0139786 A1
(43) Pub. Date: May 1, 2025

(54) METHOD AND SYSTEM FOR AUTOMATIC SEGMENTATION OF STRUCTURES OF INTEREST IN MR IMAGES USING A WEIGHTED ACTIVE SHAPE MODEL

(71) Applicant: VANDERBILT UNIVERSITY, Nashville, TN (US)

(72) Inventors: Benoit M. Dawant, Nashville, TN (US); Yubo Fan, Nashville, TN (US); Jack H. Noble, Nashville, TN (US); Robert F. Labadie, Nashville, TN (US); Rueben A. Banalagay, Nashville, TN (US)

(21) Appl. No.: 18/693,572

(22) PCT Filed: Sep. 28, 2022
(86) PCT No.: PCT/US2022/044970

§ 371 Date: Mar. 20, 2024

Related U.S. Application Data
(60) Provisional application No. 63/249,125, filed on Sep. 28, 2021.

(51) Int. Cl. G06T 7/149; G06T 3/147; G06T 7/13; G06V 10/75

(52) U.S. Cl. CPC G06T 7/149; G06T 3/147; G06T 7/13; G06V 10/7553; G06T 2207/10081; G06T 2207/10088; G06T 2207/30004

(57) ABSTRACT

Methods and systems for automatic segmentation of structures of interest of an organ in an MR image. The method includes creating a weighted active shape model (wASM); registering model points of the structures in an MR atlas image to a target image that is the MR image to be segmented, as initial model points of the structures in the target image; and iteratively fitting the wASM to the target image, starting from the initial model points, until the shape converges, wherein the final shape is the segmentation of the structures of interest.

### CROSS-REFERENCE TO RELATED PATENT APPLICATIONS

This application claims priority to and the benefit of U.S. Provisional Patent Application Ser. No. 63/249,125, filed Sep. 28, 2021, which is incorporated herein in its entirety by reference.

### STATEMENT AS TO RIGHTS UNDER FEDERALLY-SPONSORED RESEARCH

This invention was made with government support under Grant Nos. R01DC014037, R01DC008408 and R01DC014462 awarded by the National Institutes of Health (NIH). The government has certain rights in the invention.

### FIELD OF THE INVENTION

The invention relates generally to cochlear implants, and more particularly, to method and system for automatic segmentation of structures of interest such as intracochlear anatomy in MR images using a weighted active shape model and applications of the same.

### BACKGROUND OF THE INVENTION

The background description provided herein is for the purpose of generally presenting the context of the present invention. The subject matter discussed in the background of the invention section should not be assumed to be prior art merely as a result of its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions. Work of the presently named inventors, to the extent it is described in the background of the invention section, as well as aspects of the description that may not otherwise qualify as prior art at the time of filing, are neither expressly nor impliedly admitted as prior art against the present invention.

The cochlea is an essential part of the human inner ear that is responsible for hearing. It is a spiral-shaped bony structure that contains three cavities: the scala vestibuli (ST), the scala tympani (SV), and the scala media (SM). The ST and the SV are filled with perilymph. They are separated by the osseous spiral lamina and meet at the helicotrema, which is the cochlear apex. The SM is located between the ST and the SV and separated by the basilar membrane and Reissner's membrane, respectively. It only occupies a small portion of the cochlea and is filled with endolymph.

Because the cochlea is a fluid-filled structure surrounded by bone, MR and CT images provide complementary information. In CT images, the surrounding bone is visible while in the MR images it is the intracochlear fluid that produces the signal. We have developed automated methods for the segmentation of all inner structures in CT images and applied them to the segmentation of images acquired before and after cochlear implant procedures.

It is noted that previous work addressing the segmentation of the inner ear in MR images does not separate the intracochlear anatomy (ICA) from the entire labyrinth. Recent work on the topic includes Zhu et al. (2017) who segment the labyrinth in MR images using level sets and a statistical shape model as prior and Vaidyanathan et al. (2021) who develop a 3D U-Net-based method to segment the labyrinth. Segmentation of the ICA is however necessary to conduct studies that relate cochlear signal to outcomes and to the best of our knowledge this has not been reported.

Therefore, a heretofore unaddressed need exists in the art to address the aforementioned deficiencies and inadequacies.

### SUMMARY OF THE INVENTION

In one aspect, the invention relates to a method for automatic segmentation of structures of interest of an organ in an MR image. The method comprises creating a weighted active shape model (wASM); registering model points of the structures in an MR atlas image to a target image that is the MR image to be segmented, as initial model points of the structures in the target image; and iteratively fitting the wASM to the target image, starting from the initial model points, until the shape converges, wherein the final shape is the segmentation of the structures of interest.

In one embodiment, the wASM is created from a set of CT images in which the structures of interest are visible, wherein the set of CT images comprises microCT (μCT) image volumes, wherein in each μCT image volume, the structures of interest are manually segmented to create a surface for each structure while maintaining point-to-point correspondence between volumes.

In one embodiment, said creating the wASM comprises establishing a point correspondence between surfaces of the structures that are manually segmented in each CT; registering the surfaces to each other with seven degrees of a freedom similarity transformation by using the points; and computing eigenvectors of the registered points' covariance matrix. Said establishing the point correspondence between the structure surfaces comprises mapping the set of CT image volumes to one of the CT image volumes chosen as a reference volume by using a non-rigid registration; and registering the surface of each CT image volume to the surface of the reference volume, so as to establish the correspondence between each point on the reference surface with the closest point in each of the registered CT image surfaces.

In one embodiment, said creating the wASM further comprises identifying edge points in the manual segmentation that correspond to region edges in each CT; and assigning the edge points a weight of 1, and all the other points (nonedge points) in the manual segmentation a weight of 0.01.

In one embodiment, the model points of the structures in the MR atlas image are obtained by performing wASM segmentation on its corresponding CT image; aligning the CT image to the MR atlas image with a rigid-body registration; and projecting the model points from the CT image to the MR atlas image.

In one embodiment, said registering the model points of the structures in the atlas image to the target image is performed by affine transformations followed by a nonrigid registration.

In one embodiment, the affine transformations are performed by registering the whole images and then a number of regions of interest (ROIs) that are empirically chosen around the organ and have enough content to permit registration, wherein the number of ROIs includes a number of large-to small-sized ROIs; and wherein after the affine transformations are computed, the nonrigid registration is performed between the ROIs of the MR atlas image and the target image.

In one embodiment, the position of the initial model points on the target image are obtained by projecting the points from the MR atlas image using a concatenation of the affine and nonrigid transformations.

In one embodiment, said iteratively fitting the wASM to the target image comprises at each iteration, adjusting every model point from the last wASM fitting to its new candidate position, wherein if said model point is an edge point, a search is performed along the surface normal of said model point, and the new candidate point is chosen to be a point with the largest gradient magnitude along the surface normal over a range from said model point, and wherein if said model point is a nonedge point, its initial position, which is the position of this corresponding point projected from the MR atlas image using the initial registration transformation, is used as the new candidate point; and fitting the wASM to the new candidate points in the weighted-least-squares scheme.

In one embodiment, the organ includes cochlea, brain, heart, or other organs of a living subject, wherein the structures of interest comprise anatomical structures in the organ.

In one embodiment, the anatomical structures comprise intracochlear anatomy (ICA).

In another aspect, the invention relates to a system comprising at least one computing device having one or more processors and a storage device storing computer executable code, wherein the computer executable code, when executed at the one or more processors, is configured to perform a method for automatic segmentation of structures of interest of an organ in an MR image. The method comprises creating a weighted active shape model (wASM); registering model points of the structures in an MR atlas image to a target image that is the MR image to be segmented, as initial model points of the structures in the target image; and iteratively fitting the wASM to the target image, starting from the initial model points, until the shape converges, wherein the final shape is the segmentation of the structures of interest.

In one embodiment, the wASM is created from a set of CT images in which the structures of interest are visible, wherein the set of CT images comprises microCT (μCT) image volumes, wherein in each μCT image volume, the structures of interest are manually segmented to create a surface for each structure while maintaining point-to-point correspondence between volumes.

In one embodiment, said creating the wASM comprises establishing a point correspondence between surfaces of the structures that are manually segmented in each CT; registering the surfaces to each other with seven degrees of a freedom similarity transformation by using the points; and computing eigenvectors of the registered points' covariance matrix. Said establishing the point correspondence between the structure surfaces comprises mapping the set of CT image volumes to one of the CT image volumes chosen as a reference volume by using a non-rigid registration; and registering the surface of each CT image volume to the surface of the reference volume, so as to establish the correspondence between each point on the reference surface with the closest point in each of the registered CT image surfaces.

In one embodiment, said creating the wASM further comprises identifying edge points in the manual segmentation that correspond to region edges in each CT; and assigning the edge points a weight of 1, and all the other points (nonedge points) in the manual segmentation a weight of 0.01.

In one embodiment, the model points of the structures in the MR atlas image are obtained by performing wASM segmentation on its corresponding CT image; aligning the CT image to the MR atlas image with a rigid-body registration; and projecting the model points from the CT image to the MR atlas image.

In one embodiment, said registering the model points of the structures in the atlas image to the target image is performed by affine transformations followed by a nonrigid registration.

In one embodiment, the affine transformations are performed by registering the whole images and then a number of regions of interest (ROIs) that are empirically chosen around the organ and have enough content to permit registration, wherein the number of ROIs includes a number of large-to small-sized ROIs; and wherein after the affine transformations are computed, the nonrigid registration is performed between the ROIs of the MR atlas image and the target image.

In one embodiment, the position of the initial model points on the target image are obtained by projecting the points from the MR atlas image using a concatenation of the affine and nonrigid transformations.

In one embodiment, said iteratively fitting the wASM to the target image comprises at each iteration, adjusting every model point from the last wASM fitting to its new candidate position, wherein if said model point is an edge point, a search is performed along the surface normal of said model point, and the new candidate point is chosen to be a point with the largest gradient magnitude along the surface normal over a range from said model point, and wherein if said model point is a nonedge point, its initial position, which is the position of this corresponding point projected from the MR atlas image using the initial registration transformation, is used as the new candidate point; and fitting the wASM to the new candidate points in the weighted-least-squares scheme.

In one embodiment, the organ includes cochlea, brain, heart, or other organs of a living subject, wherein the structures of interest comprise anatomical structures in the organ.

In one embodiment, the anatomical structures comprise intracochlear anatomy (ICA).

In a further aspect, the invention relates to a non-transitory tangible computer-readable medium storing computer executable code, wherein the computer executable code, when executed at the one or more processors, is configured to perform a method for automatic segmentation of structures of interest of an organ in an MR image. The method comprises creating a weighted active shape model (wASM); registering model points of the structures in an MR atlas image to a target image that is the MR image to be segmented, as initial model points of the structures in the target image; and iteratively fitting the wASM to the target image, starting from the initial model points, until the shape converges, wherein the final shape is the segmentation of the structures of interest.

In one embodiment, the wASM is created from a set of CT images in which the structures of interest are visible, wherein the set of CT images comprises microCT (μCT) image volumes, wherein in each μCT image volume, the structures of interest are manually segmented to create a surface for each structure while maintaining point-to-point correspondence between volumes.

In one embodiment, said creating the wASM comprises establishing a point correspondence between surfaces of the structures that are manually segmented in each CT; registering the surfaces to each other with seven degrees of a freedom similarity transformation by using the points; and computing eigenvectors of the registered points' covariance matrix.

Said establishing the point correspondence between the structure surfaces comprises mapping the set of CT image volumes to one of the CT image volumes chosen as a reference volume by using a non-rigid registration; and registering the surface of each CT image volume to the surface of the reference volume, so as to establish the correspondence between each point on the reference surface with the closest point in each of the registered CT image surfaces.

In one embodiment, said creating the wASM further comprises identifying edge points in the manual segmentation that correspond to region edges in each CT; and assigning the edge points a weight of 1, and all the other points (nonedge points) in the manual segmentation a weight of 0.01.

In one embodiment, the model points of the structures in the MR atlas image are obtained by performing wASM segmentation on its corresponding CT image; aligning the CT image to the MR atlas image with a rigid-body registration; and projecting the model points from the CT image to the MR atlas image.

In one embodiment, said registering the model points of the structures in the atlas image to the target image is performed by affine transformations followed by a nonrigid registration.

In one embodiment, the affine transformations are performed by registering the whole images and then a number of regions of interest (ROIs) that are empirically chosen around the organ and have enough content to permit registration, wherein the number of ROIs includes a number of large-to small-sized ROIs; and wherein after the affine transformations are computed, the nonrigid registration is performed between the ROIs of the MR atlas image and the target image.

In one embodiment, the position of the initial model points on the target image are obtained by projecting the points from the MR atlas image using a concatenation of the affine and nonrigid transformations.

In one embodiment, said iteratively fitting the wASM to the target image comprises at each iteration, adjusting every model point from the last wASM fitting to its new candidate position, wherein if said model point is an edge point, a search is performed along the surface normal of said model point, and the new candidate point is chosen to be a point with the largest gradient magnitude along the surface normal over a range from said model point, and wherein if said model point is a nonedge point, its initial position, which is the position of this corresponding point projected from the MR atlas image using the initial registration transformation, is used as the new candidate point; and fitting the wASM to the new candidate points in the weighted-least-squares scheme.

In one embodiment, the organ includes cochlea, brain, heart, or other organs of a living subject, wherein the structures of interest comprise anatomical structures in the organ.

In one embodiment, the anatomical structures comprise intracochlear anatomy (ICA).

These and other aspects of the present invention will become apparent from the following description of the preferred embodiments, taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the invention and, together with the written description, serve to explain the principles of the invention. The same reference numbers may be used throughout the drawings to refer to the same or like elements in the embodiments.

FIG. 1 shows the regions of interest (ROIs), as shown in rectangles, used to register the atlas to other volumes according to the embodiments of the invention. Axial view (left panel), coronal view (top right panel), and sagittal view (bottom right panel).

FIG. 2 shows the CT image (left panel) and its corresponding T2-weighted MR image (right panel) according to the embodiments of the invention. The red contour shows the ST segmentation, and the blue contour shows the SV segmentation.

FIG. 3 shows DSC and ASD results according to the embodiments of the invention.

FIG. 4 is an example of abnormal MR signals. For this case, DSC is 0.67 and 0.59 for the ST and the SV. Yellow contour: segmentation in MR; Red contour: segmentation in CT; white arrows: abnormal MR signals.

### DETAILED DESCRIPTION OF THE INVENTION

The invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this invention will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

It will be understood that, as used in the description herein and throughout the claims that follow, the meaning of “a”, “an”, and “the” includes plural reference unless the context clearly dictates otherwise. Also, it will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Furthermore, relative terms, such as “lower” or “bottom” and “upper” or “top,” may be used herein to describe one element's relationship to another element as illustrated in the figures. It will be understood that relative terms are intended to encompass different orientations of the device in addition to the orientation depicted in the figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures. is turned over, elements described as “below” or “beneath” other elements would then be oriented “above” the other elements. The exemplary terms “below” or “beneath” can, therefore, encompass both an orientation of above and below.

It will be further understood that the terms “comprises” and/or “comprising,” or “includes” and/or “including” or “has” and/or “having”, or “carry” and/or “carrying,” or “contain” and/or “containing,” or “involve” and/or “involving, and the like are to be open-ended, i.e., to mean including but not limited to. When used in this invention, they specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present invention, and will not be interpreted in an idealized or overly formal sense unless expressly so defined herein.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprise” or “comprising”, “include” or “including”, “carry” or “carrying”, “has/have” or “having”, “contain” or “containing”, “involve” or “involving” and the like are to be understood to be open-ended, i.e., to mean including but not limited to.

As used herein, the phrase “at least one of A, B, and C” should be construed to mean a logical (A or B or C), using a non-exclusive logical OR. It should be understood that one or more steps within a method may be executed in different order (or concurrently) without altering the principles of the invention.

The description below is merely illustrative in nature and is in no way intended to limit the invention, its application, or uses. The broad teachings of the invention can be implemented in a variety of forms. Therefore, while this invention includes particular examples, the true scope of the invention should not be so limited since other modifications will become apparent upon a study of the drawings, the specification, and the following claims. For purposes of clarity, the same reference numbers will be used in the drawings to identify similar elements. It should be understood that one or more steps within a method may be executed in different order (or concurrently) without altering the principles of the invention.

Segmentation of MR images is important because cochlear MR signal intensity has a clear relationship with hearing loss in untreated acoustic neuroma (AN) patients and predicts hearing outcomes after microsurgical resection and stereotactic radiosurgery. The biomolecular processes underlying degraded cochlear T2 signal remain unclear, but it is thought that they reflect increased protein concentration in the cochlear fluids, which has been observed in perilymph samples from cochleae of ears affected by AN. Whether the cochlear MR signal intensity at the time of AN diagnosis can predict long-term hearing outcomes in patients with untreated AN remains unknown, and it is unclear whether cochlear MR signal intensity precedes, coincides with, or follows observed deterioration in hearing over time.

Automated methods would permit large-scale retrospective studies and routine computation of these quantities, thus potentially facilitating prognostication of hearing outcomes in AN. Cochlear MR signal is also used to detect cochlear obliteration after AN surgery to evaluate patients for subsequent cochlear implantation. Moreover, MR images can serve as a radiation-free alternative to preoperative CT images for planning cochlear implantation surgeries.

In view of the foregoing, one of the objectives of this invention is provide methods and systems for automatic segmentation of structures of interest of an organ in an MR image. In one embodiment, the organ includes cochlea, brain, heart, or other organs of a living subject such a human being, where the structures of interest comprise anatomical structures in the organ. In one embodiment, the anatomical structures comprise intracochlear anatomy (ICA).

In one aspect of the invention, the method comprises creating a weighted active shape model (wASM) from a set of CT images in which the structures of interest are visible, wherein the set of CT images comprises microCT (μCT) image volumes, wherein in each μCT image volume, the structures of interest are manually segmented to create a surface for each structure while maintaining point-to-point correspondence between volumes.

In one embodiment, said creating the wASM comprises establishing a point correspondence between surfaces of the structures that are manually segmented in each CT; registering the surfaces to each other with seven degrees of a freedom similarity transformation by using the points; and computing eigenvectors of the registered points' covariance matrix. Said establishing the point correspondence between the structure surfaces comprises mapping the set of CT image volumes to one of the CT image volumes chosen as a reference volume by using a non-rigid registration; and registering the surface of each CT image volume to the surface of the reference volume, so as to establish the correspondence between each point on the reference surface with the closest point in each of the registered CT image surfaces.

In one embodiment, said creating the wASM further comprises identifying edge points in the manual segmentation that correspond to region edges in each CT; and assigning the edge points a weight of 1, and all the other points (nonedge points) in the manual segmentation a weight of 0.01.

The method further comprises registering model points of the structures in an MR atlas image to a target image that is the MR image to be segmented, as initial model points of the structures in the target image.

In one embodiment, the model points of the structures in the MR atlas image are obtained by performing wASM segmentation on its corresponding CT image; aligning the CT image to the MR atlas image with a rigid-body registration; and projecting the model points from the CT image to the MR atlas image.

In one embodiment, said registering the model points of the structures in the atlas image to the target image is performed by affine transformations followed by a nonrigid registration.

In one embodiment, the affine transformations are performed by registering the whole images and then a number of regions of interest (ROIs) that are empirically chosen around the organ and have enough content to permit registration, wherein the number of ROIs includes a number of large-to small-sized ROIs; and wherein after the affine transformations are computed, the nonrigid registration is performed between the ROIs of the MR atlas image and the target image.

In one embodiment, the position of the initial model points on the target image are obtained by projecting the points from the MR atlas image using a concatenation of the affine and nonrigid transformations.

The method also comprises iteratively fitting the wASM to the target image, starting from the initial model points, until the shape converges, wherein the final shape is the segmentation of the structures of interest.

In one embodiment, said iteratively fitting the wASM to the target image comprises at each iteration, adjusting every model point from the last wASM fitting to its new candidate position, wherein if said model point is an edge point, a search is performed along the surface normal of said model point, and the new candidate point is chosen to be a point with the largest gradient magnitude along the surface normal over a range from said model point, and wherein if said model point is a nonedge point, its initial position, which is the position of this corresponding point projected from the MR atlas image using the initial registration transformation, is used as the new candidate point; and fitting the wASM to the new candidate points in the weighted-least-squares scheme. In one embodiment, the initial registration transformation is the one that registers the model points of the structures in the MR atlas image to the target image.

To the inventors' best knowledge, the above disclosed method is the first method that permits the automated segmentation of the components/structures in the inner ear, i.e., the ST, the SV, and the modiolus in MR images. The method is accurate and fully automated for MR image segmentation. It can be used to support large retrospective studies that explore relations between MR signal in preoperative images and outcomes. It can also facilitate the routine and clinical use of this information.

In another aspect of the invention, the system comprises at least one computing device having one or more processors and a storage device storing computer executable code, wherein the computer executable code, when executed at the one or more processors, is configured to perform the above disclosed method for automatic segmentation of structures of interest of an organ in an MR image.

It should be noted that all or a part of the steps according to the embodiments of the present invention is implemented by hardware or a program instructing relevant hardware. Yet another aspect of the invention provides a non-transitory computer readable storage medium/memory which stores computer executable instructions or program codes. The computer executable instructions or program codes enable a system to complete various operations in the above disclosed methods for automatic segmentation of structures of interest such as intracochlear anatomy in MR images using a weighted active shape model. The storage medium/memory may include, but is not limited to, high-speed random access medium/memory such as DRAM, SRAM, DDR RAM or other random access solid state memory devices, and non-volatile memory such as one or more magnetic disk storage devices, optical disk storage devices, flash memory devices, or other non-volatile solid state storage devices.

Without intent to limit the scope of the invention, examples and their related results according to the embodiments of the present invention are given below. Note that titles or subtitles may be used in the examples for convenience of a reader, which in no way should limit the scope of the invention. Moreover, certain theories are proposed and disclosed herein; however, in no way they, whether they are right or wrong, should limit the scope of the invention so long as the invention is practiced according to the invention without regard for any particular theory or scheme of action.

### Example

### Automatic Segmentation of Intracochlear Anatomy in Mr Images Using a Weighted Active Shape Model

There is evidence that cochlear MR signal intensity may be useful in prognosticating the risk of hearing loss after middle cranial fossa (MCF) resection of acoustic neuroma (AN), but the manual segmentation of this structure is difficult and prone to error. This hampers both large-scale retrospective studies and routine clinical use of this information.

To address this issue, we disclose in this exemplary study a fully automatic method for segmentation of the intracochlear anatomy (ICA) in MR images, which uses a weighted active shape model (wASM) we have developed and validated to segment the intracochlear anatomy in CT images. We take advantage of a dataset for which both CT and MR images are available to validate our method on 132 ears in 66 high-resolution T2-weighted MR images. Using the CT segmentation as ground truth, we achieve a mean Dice (DSC) value of 0.81 and 0.79 for the scala tympani (ST) and the scala vestibuli (SV), which are the two main intracochlear structures.

### Methods

The method for the segmentation of the ICA in MR images is adapted from our previously developed wASM method to segment the same structures in CT images. We modify this method, as discussed in the following sections, to make it applicable to the T2-weighted images included in this exemplary study.

Shape Model Creation: Briefly, a series of microCT (μCT) image volumes (a typical isotropic voxel dimension of 0.036 mm) in which the intracochlear anatomy is visible is used to build the shape model. The ST and SV are manually delineated in each of the microCT image volumes to create a surface for each structure while maintaining point-to-point correspondence between volumes. The covariance matrix of the vertices is created and its eigenvectors are computed to produce the eigenmodes of deformation.

Segmentation Using the Weighted Active Shape Model (wASM): After the shape model is built, the segmentation can be performed by (1) placing the initial shape in the target image, i.e., the image to be segmented; (2) iteratively fitting the wASM to the target image; and (3) after the fitting converges, use the final shape as the segmentation result. The whole process is fully automatic, and is detailed as follows.
1) Initialization: The aim of initialization is to localize the cochlea and place initial model points in the target image, which is done by registering an MR atlas image to the target image. Without loss of generality, we assume that the cochlea to be segmented is in the left ear. If it is in the right, we begin the process by mirroring the target image. The MR atlas image is acquired with a FIESTA sequence on a 3 T scanner, with voxel size 0.3125 mm×0.3125 mm×0.4 mm. To obtain the intracochlear anatomy model points in this MR atlas, we first perform the wASM segmentation on its corresponding CT image using the method developed by Noble et al. (2013), then align the CT and MR images with a rigid-body registration, and finally project the model points from the CT volume to the MR atlas image.

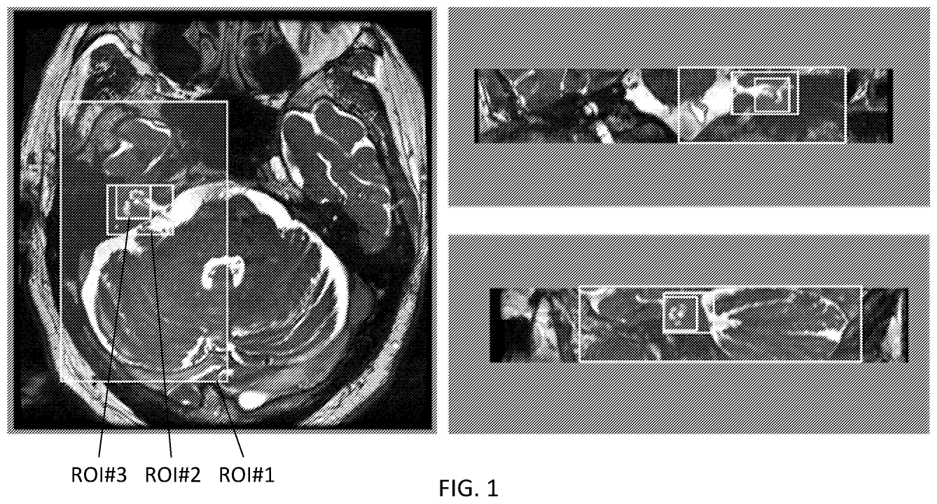

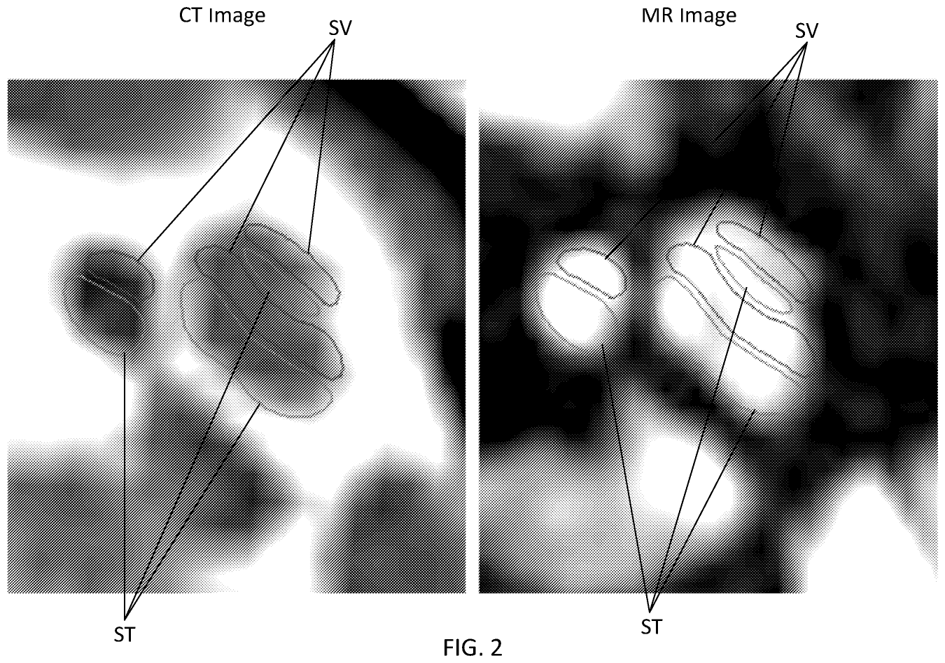

The registration process between the atlas image and the target image includes an affine followed by a nonrigid registration. Because all the high-resolution T2-weighted images (including the atlas image, see FIG. 1) were obtained with an acquisition protocol that covers only a small part of the head in the superior-inferior direction (usually less than 30 mm), we follow a four-step process to improve convergence and registration accuracy in the cochlear region. We first register the whole images and then three regions of interest (ROIs) that are empirically chosen around the cochlea and have enough content to permit registration. We call ROI #1, ROI #2, and ROI #3 the three large-to small-sized ROIs shown in FIG. 1. ROI #1 has a size of 65 mm×107 mm×28 mm and is chosen to cover the left-half of the brain. ROI #2 contains the whole labyrinth and the inner auditory canal of the left ear. The strong T2-weighted signals of the perilymph, endolymph, and cerebrospinal fluid make it easy to distinguish from the surrounding non-fluid anatomy. ROI #3 is smaller than ROI #2 but still covers the cochlea. It is selected to produce a very accurate registration of the cochlea. After the above affine transformations are computed, a nonrigid registration is performed between the cochlear ROIs (ROI #3) of the atlas image and the target image. The position of the initial model points on the target image can then be obtained by projecting the points from the atlas image using a concatenation of the affine and nonrigid transformations. Finally, the shape model is fitted to the initial point-set in a weighted-least-square sense to initialize the iterative search.
2) Iterative Search: Following the wASM approach put forth in Noble et al. (2013), the model starts from a set of initial model points, and the optimal solution is computed in the target image iteratively until the shape converges. Two sets of model points were pre-defined in the wASM approach proposed to segment CT images: “edge” points and “nonedge” points. The edge points are located on the cochlear external walls and have strong image gradients. The nonedge points are the remaining points without salient image features. They were treated differently in the candidate point adjustment step and given different weights (1 for edge points and 0.01 for nonedge points) in the wASM fitting process. For the MR images used in this exemplary study, i.e., high-resolution T2-weighted MR images, although the image contrast is provided by the fluid signal, the points located close to the cochlear external walls have strong image gradients. An example of registered CT and MR images showing the cochlea is shown in FIG. 2. Also, note that even though the separation between the ST and the SV within the cochlea can be discernable in high-resolution T2-weighted MR images, we observe that the image gradients at these locations are very weak compared to the cochlear external walls and sometimes even nonexistent. As a result, we followed the approach described in Noble et al. (2011) and used the same model point subsets and weights to fit the ASM to the MR images.

Specifically, at each iteration, every model point \vec{y}ᵢ from the last wASM fitting is adjusted to its new candidate position. If \vec{y}ᵢ is an edge point, a search is performed along the surface normal of that point. The adjusted candidate point \vec{y}ᵢ′ is chosen to be the point with the largest gradient magnitude along the surface normal over the range of −1 mm to 1 mm from \vec{y}ᵢ. If \vec{y}ᵢ is a nonedge point, then its initial position, which is the position of this corresponding point projected from the atlas image using the initial registration transformation, is used as the new candidate point \vec{y}ᵢ′. The next step within this iteration is to fit the shape model to the candidate points in the weighted-least-squares sense/scheme. A 7 degree-of-freedom weighted point registration between the candidate shape and the mean shape v̅ is performed to get the transformation T. The residuals are computed as

$$\vec{d} = T ( {\vec{y}}^{′} ) - \overline{v} . \qquad ( 1 )$$

The weighted-least-square fit is solved as

$$\vec{b} = {( {U}^{T} {W}^{T} W U )}^{- 1} {U}^{T} {W}^{T} W \vec{d} , \qquad ( 2 )$$

where U is the matrix of eigenvectors, W is the diagonal matrix point weights. The coefficient \vec{b} is constrained such that the Mahalanobis distance between the fitted shape and the mean shape is not greater than 3, i.e.,

$$\sqrt{{\sum }_{j = 1}^{N - 1} \frac{{b}_{j}^{2}}{{λ}_{j}}} \leq 3. \qquad ( 3 )$$

The estimated shape after this wASM fitting is then given by

$$\vec{y} = {T}^{- 1} ( \overline{v} + U \vec{b} ) . \qquad ( 4 )$$

The process of candidate point searching and wASM fitting is iterated until convergence, and the final shape is the segmentation result.

Validation: Because our previously developed wASM method to segment the ICA in CT images has been applied to various clinical applications and shown to be robust and accurate and because contouring the cochlea in 132 ears would be impractical, we utilize the wASM method to create the ground truth. Specifically, we first segment the paired CT and MR images individually (note that the wASM methods in both the CT and MR share the same shape model), then rigidly register the CT image to the MR image using the same mutual information-based registration technique above. Finally, we project the CT segmentation result onto the MR image to provide the ground truth. Dice similarity coefficient (DSC) and the average surface distance (ASD) are calculated between the wASM segmentation of the MR images and the ground truth. For DSC, which measures the volumetric overlap, we denote the binary mask of each segmented ICA structures in CT and MR images B_{CT} and B_{MR}. |X| represents the number of voxels in the binary mask X. DSC is computed as

$$D S C ( {B}_{MR} , {B}_{C T} ) = 2 \frac{\vert {B}_{M R} ⋂ {B}_{C T} \vert}{\vert {B}_{M R} \vert + \vert {B}_{C T} \vert} . \qquad ( 5 )$$

For ASD, which measures the average symmetric distance between the surface meshes, we define M_{CT} as the segmented surface mesh in the CT image and M_{MR} as the segmented mesh in the MR image. The ASD is then computed as

$$A S D ( {M}_{MR} , {M}_{C T} ) = \frac{D ( {M}_{MR} , {M}_{C T} ) + D ( {M}_{CT} , {M}_{M R} )}{2} , \qquad ( 6 )$$

where D (M_{MR}, M_{CT}) is the average distance from every point on M_{MR} to the surface of M_{CT} and vice versa.

The evaluation using the DSC and ASD requires an accurate registration between the paired CT and MR images, but we visually observed that small registration errors can remain after automated registration. To factor this error out, we obtain the rigid transformation between the CT and MR images by performing a point-based registration between the point-sets of the CT wASM result and the MR wASM result. We subsequently calculate the DSC and ASD between the transformed CT segmentation and the MR segmentation. We consider the evaluation results obtained in this way to be the lower bound because this registration process minimizes the point-to-point distance between the two segmentations (point-sets) before calculating the evaluation metrics.

### EXPERIMENTS AND RESULTS

Imaging Data: We retrospectively collected preoperative images of 66 cochlear implant recipients treated at the Vanderbilt University Medical Center. Each patient had undergone preoperative CT and MR imaging of the temporal bone. The CT images were acquired with a Revolution EVO (GE Healthcare) scanner. For these images, a typical voxel dimension is 0.47 mm×0.47 mm×0.1 mm. The MR images were acquired with 3 T MR scanners from different vendors (GE Healthcare, Philips Healthcare, and Siemens Healthcare). A number of high-resolution T2-weighted MR sequences, including FIESTA, bFFE, CISS, DRIVE, SPACE were used to scan the patients and were included in the study. Images acquired with the FIESTA sequence made up 82% of the MR images. For these, a typical voxel dimension is 0.3125 mm×0.3125 mm×0.4 mm.

Results: The novel segmentation method is tested on 132 ears of 66 subjects. The registration and wASM segmentation for each ear takes about 2 minutes. The process is fully automated but failed for 12/132 ears. These cases required a manual alignment between the atlas MR image and the target MR image to localize the cochlea before the wASM segmentation because of imaging artifacts or pathologies that affected the registration process.

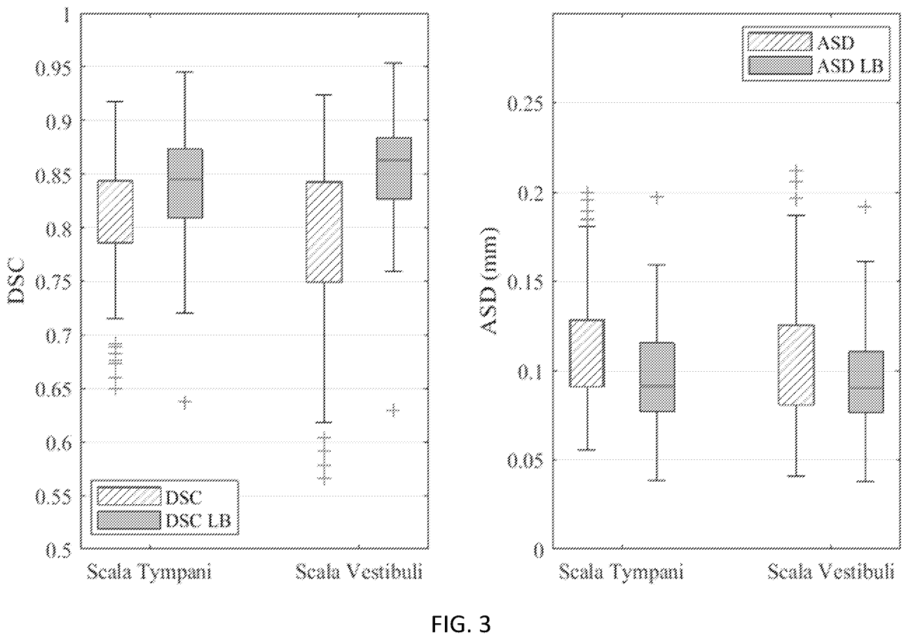

FIG. 3 shows the DSC and ASD of the ST and the SV for the 132 cochleae. Metrics with “LB” (lower bound) indicate that the evaluation is performed after the point registration. We report the mean DSC for the ST and the SV equal to 0.81 and 0.79, respectively. The mean ASD for the ST and the SV are both 0.11 mm, which is far smaller than the typical voxel dimension of the MR images.

### DISCUSSION AND CONCLUSIONS

In this exemplary example, we disclose a wASM-based method to segment the ICA in T2-weighted MR images. In the fully automated pipeline we have developed, the cochlea is first localized using a series of registrations, and then the wASM is fitted to the cochlea iteratively in the target image. To evaluate the results, we use the same shape model to segment the corresponding CT images and calculate the DSC and ASD between the two segmentation results, achieving a mean DSC of 0.81 and 0.79 for the two ICA structures. These results are promising and show that this automated segmentation method could potentially be used to conduct large-scale studies to, for instance, find correlations between cochlear MR signal and hearing outcomes over time in AN patients. It may also enable the routine and clinical use of this cochlear signal information.

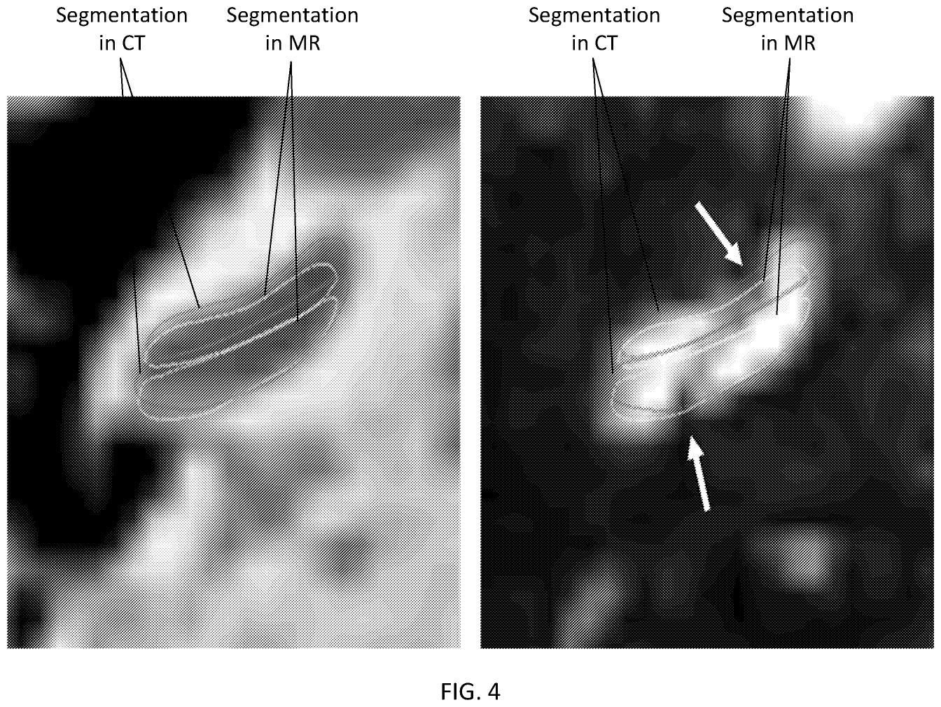

We observe that abnormal MR signal occurs in several cases, e.g., local hypointensity within the cochlea. This may be caused by cochlear pathologies and it affects the segmentation results. FIG. 4 shows such an example but we note that the segmentation in this MR image remains reasonable because of the robust nature of the wASM. One possible improvement is to adaptively downweight the outlier points during the fitting. In addition, since the image registration-based cochlear localization fails on 12/132 of the cases, we will explore alternative machine learning-based methods as we have done to register an atlas and other volumes to segment the cochlea in CT images.

In sum, according to the invention, the novel method is accurate and fully automated for MR image segmentation. It can be used to support large retrospective studies that explore relations between MR signal in preoperative images and outcomes. It can also facilitate the routine and clinical use of this information.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the invention pertains without departing from its spirit and scope. Accordingly, the scope of the invention is defined by the appended claims rather than the foregoing description and the exemplary embodiments described therein.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### LIST OF REFERENCES

[1] P. Digge, “Imaging Modality of Choice for Pre-Operative Cochlear Imaging: HRCT vs. MRI Temporal Bone,” J. Clin. Diagn. Res., 2016, doi: 10.7860/JCDR/2016/18033.8592.
[2] V. M. Joshi, S. K. Navlekar, G. R. Kishore, K. J. Reddy, and E. C. V. Kumar, “CT and MR Imaging of the Inner Ear and Brain in Children with Congenital Sensorineural Hearing Loss,” RadioGraphics, vol. 32, no. 3, pp. 683-698, May 2012, doi: 10.1148/rg.323115073.
[3] J. H. Noble, R. F. Labadie, O. Majdani, and B. M. Dawant, “Automatic Segmentation of Intracochlear Anatomy in Conventional CT,” IEEE Trans. Biomed. Eng., vol. 58, no. 9, pp. 2625-2632 Sep. 2011, doi: 10.1109/TBME.2011.2160262.
[4] J. H. Noble, R. F. Labadie, R. H. Gifford, and B. M. Dawant, “Image-Guidance Enables New Methods for Customizing Cochlear Implant Stimulation Strategies,” IEEE Trans. Neural Syst. Rehabil. Eng., vol. 21, no. 5, pp. 820-829, September 2013, doi: 10.1109/TNSRE.2013.2253333.
[5] A. J. Bowen, M. L. Carlson, and J. I. Lane, “Inner Ear Enhancement With Delayed 3D-FLAIR MRI Imaging in Vestibular Schwannoma,” Otol. Neurotol., vol. 41, no. 9, pp. 1274-1279 Oct. 2020, doi: 10.1097/MAO.0000000000002768.
[6] M. E. Miller et al., “Hearing Preservation and Vestibular Schwannoma: Intracochlear FLAIR Signal Relates to Hearing Level,” Otol. Neurotol., vol. 35, no. 2, pp. 348-352, February 2014, doi: 10.1097/MAO.0000000000000191.
[7] K. O. Tawfik, M. McDonald, Y. Ren, O. Moshtaghi, M. S. Schwartz, and R. A. Friedman, “Cochlear T2 Signal May Predict Hearing Outcomes After Resection of Acoustic Neuroma,” Otology & Neurotology, July 2021, doi: 10.1097/MAO.0000000000003228.
[8] V. Prabhu et al., “Preserved Cochlear CISS Signal is a Predictor for Hearing Preservation in Patients Treated for Vestibular Schwannoma With Stereotactic Radiosurgery,” Otol. Neurotol., vol. 39, no. 5, pp. 628-631, June 2018, doi: 10.1097/MAO.0000000000001762.
[9] J. Haneda, K. Ishikawa, and K. Okamoto, “Better continuity of the facial nerve demonstrated in the temporal bone on three-dimensional T1-weighted imaging with volume isotropic turbo spin echo acquisition than that with fast field echo at 3.0 tesla MRI,” J. Med. Imaging Radiat. Oncol., vol. 63, no. 6, pp. 745-750, December 2019, doi: 10.1111/1754-9485.12962.
[10] O. Af, F. Mw, and M. Aw, “Perilymph total protein levels associated with cerebellopontine angle lesions,” Am. J. Otol., vol. 2, no. 3, pp. 193-195, January 1981.
[11] Y. Feng, J. I. Lane, C. M. Lohse, and M. L. Carlson, “Pattern of cochlear obliteration after vestibular Schwannoma resection according to surgical approach,” The Laryngoscope, vol. 130, no. 2, pp. 474-481, 2020, doi: https://doi.org/10.1002/lary.27945.
[12] N. West, H. C. R. Sass, M. N. Møller, and P. Caye-Thomasen, “Cochlear MRI Signal Change Following Vestibular Schwannoma Resection Depends on Surgical Approach,” Otol. Neurotol., vol. 40, no. 10, p. e999, December 2019, doi: 10.1097/MAO.0000000000002361.
[13] F. C. E. Hill, A. Grenness, S. Withers, C. Iseli, and R. Briggs, “Cochlear Patency After Translabyrinthine Vestibular Schwannoma Surgery,” Otol. Neurotol., vol. 39, no. 7, p. e575, August 2018, doi: 10.1097/MAO.0000000000001858.
[14] S. Zhu, W. Gao, Y. Zhang, J. Zheng, Z. Liu, and G. Yuan, “3D automatic MRI level set segmentation of inner ear based on statistical shape models prior,” in 2017 10th International Congress on Image and Signal Processing, BioMedical Engineering and Informatics (CISP-BMEI), October 2017, pp. 1-6, doi: 10.1109/CISP-BMEI.2017.8301973.
[15] A. Vaidyanathan et al., “Deep learning for the fully automated segmentation of the inner ear on MRI,” Sci. Rep., vol. 11, no. 1, Art. no. 1, February 2021, doi: 10.1038/s41598-021-82289-y.
[16] T. F. Cootes, C. J. Taylor, D. H. Cooper, and J. Graham, “Active Shape Models-Their Training and Application,” Comput. Vis. Image Underst., vol. 61, no. 1, pp. 38-59, January 1995, doi: 10.1006/cviu. 1995.1004.
[17] F. Maes, A. Collignon, D. Vandermeulen, G. Marchal, and P. Suetens, “Multimodality image registration by maximization of mutual information,” IEEE Trans. Med. Imaging, vol. 16, no. 2, pp. 187-198, April 1997, doi: 10.1109/42.563664.
[18] G. K. Rohde, A. Aldroubi, and B. M. Dawant, “The adaptive bases algorithm for intensity-based nonrigid image registration,” IEEE Trans. Med. Imaging, vol. 22, no. 11, pp. 1470-1479 November 2003, doi: 10.1109/TMI.2003.819299.
[19] J. C. Benson, M. L. Carlson, and J. I. Lane, “MRI of the Internal Auditory Canal, Labyrinth, and Middle Ear: How We Do It,” Radiology, vol. 297, no. 2, pp. 252-265, September 2020, doi: 10.1148/radiol.2020201767.
[20] R. F. Labadie and J. H. Noble, “Preliminary Results With Image-guided Cochlear Implant Insertion Techniques,” Otol. Neurotol., vol. 39, no. 7, p. 922, August 2018, doi: 10.1097/MAO.0000000000001850.
[21] A. Rivas et al., “Automatic Cochlear Duct Length Estimation for Selection of Cochlear Implant Electrode Arrays,” Otol. Neurotol., vol. 38, no. 3, p. 339, March 2017, doi: 10.1097/MAO.0000000000001329.
[22] R. Banalagay, R. F. L. M.d, and J. Noble, “Validation of active shape model techniques for intra-cochlear anatomy segmentation in CT images,” in Medical Imaging 2021: Image Processing, February 2021, vol. 11596, p. 115961M, doi: 10.1117/12.2582096.
[23] L. R. Dice, “Measures of the Amount of Ecologic Association Between Species,” Ecology, vol. 26, no. 3, pp. 297-302, 1945, doi: 10.2307/1932409.
[24] D. Zhang, J. Wang, J. H. Noble, and B. M. Dawant, “HeadLocNet: Deep convolutional neural networks for accurate classification and multi-landmark localization of head CTs,” Med. Image Anal., vol. 61, p. 101659, April 2020, doi: 10.1016/j.media.2020.101659.

What is claimed is:

1. A method for automatic segmentation of structures of interest of an organ in an MR image, comprising:
creating a weighted active shape model (wASM);
registering model points of the structures in an MR atlas image to a target image that is the MR image to be segmented, as initial model points of the structures in the target image; and
iteratively fitting the wASM to the target image, starting from the initial model points, until the shape converges, wherein the final shape is the segmentation of the structures of interest.

2. The method of claim 1, wherein the wASM is created from a set of CT images in which the structures of interest are visible, wherein the set of CT images comprises microCT (μCT) image volumes, wherein in each μCT image volume, the structures of interest are manually segmented to create a surface for each structure while maintaining point-to-point correspondence between volumes.

3. The method of claim 2, wherein said creating the wASM comprises:
establishing a point correspondence between surfaces of the structures that are manually segmented in each CT;
registering the surfaces to each other with seven degrees of a freedom similarity transformation by using the points; and
computing eigenvectors of the registered points' covariance matrix,
wherein said establishing the point correspondence between the structure surfaces comprises:
mapping the set of CT image volumes to one of the CT image volumes chosen as a reference volume by using a non-rigid registration; and
registering the surface of each CT image volume to the surface of the reference volume, so as to establish the correspondence between each point on the reference surface with the closest point in each of the registered CT image surfaces.

4. The method of claim 3, wherein said creating the wASM further comprises:
identifying edge points in the manual segmentation that correspond to region edges in each CT; and
assigning the edge points a weight of 1, and all the other points (nonedge points) in the manual segmentation a weight of 0.01.

5. The method of claim 1, wherein the model points of the structures in the MR atlas image are obtained by
performing wASM segmentation on its corresponding CT image;
aligning the CT image to the MR atlas image with a rigid-body registration; and
projecting the model points from the CT image to the MR atlas image.

6. The method of claim 1, wherein said registering the model points of the structures in the atlas image to the target image is performed by affine transformations followed by a nonrigid registration.

7. The method of claim 6, wherein the affine transformations are performed by registering the whole images and then a number of regions of interest (ROIs) that are empirically chosen around the organ and have enough content to permit registration, wherein the number of ROIs includes a number of large- to small-sized ROIs; and wherein after the affine transformations are computed, the nonrigid registration is performed between the ROIs of the MR atlas image and the target image.

8. The method of claim 7, wherein the position of the initial model points on the target image are obtained by projecting the points from the MR atlas image using a concatenation of the affine and nonrigid transformations.

9. The method of claim 1, wherein said iteratively fitting the wASM to the target image comprises at each iteration,
adjusting every model point from the last wASM fitting to its new candidate position, wherein if said model point is an edge point, a search is performed along the surface normal of said model point, and the new candidate point is chosen to be a point with the largest gradient magnitude along the surface normal over a range from said model point, and wherein if said model point is a nonedge point, its initial position, which is the position of this corresponding point projected from the MR atlas image using the initial registration transformation, is used as the new candidate point; and
fitting the wASM to the new candidate points in the weighted-least-squares scheme.

10. The method of claim 1, wherein the organ includes cochlea, brain, heart, or other organs of a living subject, wherein the structures of interest comprise anatomical structures in the organ.

11. The method of claim 10, wherein the anatomical structures comprise intracochlear anatomy (ICA).

12. A system, comprising: at least one computing device having one or more processors and a storage device storing computer executable code, wherein the computer executable code, when executed at the one or more processors, is configured to perform a method for automatic segmentation of structures of interest of an organ in an MR image, the method comprising:
creating a weighted active shape model (wASM);
registering model points of the structures in an MR atlas image to a target image that is the MR image to be segmented, as initial model points of the structures in the target image; and
iteratively fitting the wASM to the target image, starting from the initial model points, until the shape converges, wherein the final shape is the segmentation of the structures of interest.

13. The system of claim 12, wherein the wASM is created from a set of CT images in which the structures of interest are visible, wherein the set of CT images comprises microCT (μCT) image volumes, wherein in each μCT image volume, the structures of interest are manually segmented to create a surface for each structure while maintaining point-to-point correspondence between volumes.

14. The system of claim 13, wherein said creating the wASM comprises:
establishing a point correspondence between surfaces of the structures that are manually segmented in each CT;
registering the surfaces to each other with seven degrees of a freedom similarity transformation by using the points; and
computing eigenvectors of the registered points' covariance matrix,
wherein said establishing the point correspondence between the structure surfaces comprises:
mapping the set of CT image volumes to one of the CT image volumes chosen as a reference volume by using a non-rigid registration; and
registering the surface of each CT image volume to the surface of the reference volume, so as to establish the correspondence between each point on the reference surface with the closest point in each of the registered CT image surfaces.

15. The system of claim 14, wherein said creating the wASM further comprises:
identifying edge points in the manual segmentation that correspond to region edges in each CT; and
assigning the edge points a weight of 1, and all the other points (nonedge points) in the manual segmentation a weight of 0.01.

16. The system of claim 12, wherein the model points of the structures in the MR atlas image are obtained by
performing wASM segmentation on its corresponding CT image;
aligning the CT image to the MR atlas image with a rigid-body registration; and
projecting the model points from the CT image to the MR atlas image.

17. The system of claim 12, wherein said registering the model points of the structures in the atlas image to the target image is performed by affine transformations followed by a nonrigid registration.

18. The system of claim 17, wherein the affine transformations are performed by registering the whole images and then a number of regions of interest (ROIs) that are empirically chosen around the organ and have enough content to permit registration, wherein the number of ROIs includes a number of large- to small-sized ROIs; and wherein after the affine transformations are computed, the nonrigid registration is performed between the ROIs of the MR atlas image and the target image.

19. The system of claim 18, wherein the position of the initial model points on the target image are obtained by projecting the points from the MR atlas image using a concatenation of the affine and nonrigid transformations.

20. The system of claim 12, wherein said iteratively fitting the wASM to the target image comprises at each iteration,
adjusting every model point from the last wASM fitting to its new candidate position, wherein if said model point is an edge point, a search is performed along the surface normal of said model point, and the new candidate point is chosen to be a point with the largest gradient magnitude along the surface normal over a range from said model point, and wherein if said model point is a nonedge point, its initial position, which is the position of this corresponding point projected from the MR atlas image using the initial registration transformation, is used as the new candidate point; and
fitting the wASM to the new candidate points in the weighted-least-squares scheme.

21. The system of claim 12, wherein the organ includes cochlea, brain, heart, or other organs of a living subject, wherein the structures of interest comprise anatomical structures in the organ.

22. The system of claim 21, wherein the anatomical structures comprise intracochlear anatomy (ICA).

23. A non-transitory tangible computer-readable medium storing computer executable code, wherein the computer executable code, when executed at the one or more processors, is configured to perform a method for automatic segmentation of structures of interest of an organ in an MR image, the method comprising:
creating a weighted active shape model (wASM);
registering model points of the structures in an MR atlas image to a target image that is the MR image to be segmented, as initial model points of the structures in the target image; and
iteratively fitting the wASM to the target image, starting from the initial model points, until the shape converges, wherein the final shape is the segmentation of the structures of interest.

24. The non-transitory tangible computer-readable medium of claim 23, wherein the wASM is created from a set of CT images in which the structures of interest are visible, wherein the set of CT images comprises microCT (μCT) image volumes, wherein in each μCT image volume, the structures of interest are manually segmented to create a surface for each structure while maintaining point-to-point correspondence between volumes.

25. The non-transitory tangible computer-readable medium of claim 24, wherein said creating the wASM comprises:
establishing a point correspondence between surfaces of the structures that are manually segmented in each CT;
registering the surfaces to each other with seven degrees of a freedom similarity transformation by using the points; and
computing eigenvectors of the registered points' covariance matrix,
wherein said establishing the point correspondence between the structure surfaces comprises:
mapping the set of CT image volumes to one of the CT image volumes chosen as a reference volume by using a non-rigid registration; and
registering the surface of each CT image volume to the surface of the reference volume, so as to establish the correspondence between each point on the reference surface with the closest point in each of the registered CT image surfaces.

26. The non-transitory tangible computer-readable medium of claim 25, wherein said creating the wASM further comprises:
identifying edge points in the manual segmentation that correspond to region edges in each CT; and
assigning the edge points a weight of 1, and all the other points (nonedge points) in the manual segmentation a weight of 0.01.

27. The non-transitory tangible computer-readable medium of claim 23, wherein the model points of the structures in the MR atlas image are obtained by
performing wASM segmentation on its corresponding CT image;
aligning the CT image to the MR atlas image with a rigid-body registration; and
projecting the model points from the CT image to the MR atlas image.

28. The non-transitory tangible computer-readable medium of claim 23, wherein said registering the model points of the structures in the atlas image to the target image is performed by affine transformations followed by a nonrigid registration.

29. The non-transitory tangible computer-readable medium of claim 28, wherein the affine transformations are performed by registering the whole images and then a number of regions of interest (ROIs) that are empirically chosen around the organ and have enough content to permit registration, wherein the number of ROIs includes a number of large- to small-sized ROIs; and wherein after the affine transformations are computed, the nonrigid registration is performed between the ROIs of the MR atlas image and the target image.

30. The non-transitory tangible computer-readable medium of claim 29, wherein the position of the initial model points on the target image are obtained by projecting the points from the MR atlas image using a concatenation of the affine and nonrigid transformations.

31. The non-transitory tangible computer-readable medium of claim 23, wherein said iteratively fitting the wASM to the target image comprises at each iteration,
adjusting every model point from the last wASM fitting to its new candidate position, wherein if said model point is an edge point, a search is performed along the surface normal of said model point, and the new candidate point is chosen to be a point with the largest gradient magnitude along the surface normal over a range from said model point, and wherein if said model point is a nonedge point, its initial position, which is the position of this corresponding point projected from the MR atlas image using the initial registration transformation, is used as the new candidate point; and
fitting the wASM to the new candidate points in the weighted-least-squares scheme.

32. The non-transitory tangible computer-readable medium of claim 23, wherein the organ includes cochlea, brain, heart, or other organs of a living subject, wherein the structures of interest comprise anatomical structures in the organ.

33. The non-transitory tangible computer-readable medium of claim 32, wherein the anatomical structures comprise intracochlear anatomy (ICA).
